(19) United States
(12) Patent Application Publication
(10) Pub. No.: US 2004/0191523 A1
(43) Pub. Date: Sep. 30, 2004

(54) Reactive hot melt adhesive formulation for joining stamped metal and plastic parts

(76) Inventor: Jihong Kye, Troy, MI (US)

Correspondence Address: Richard W. Hoffmann, PO Box 70098, Rochester Hills, MI, 48307, US

(21) Appl. No.: 10/395,511

(22) Filed: Mar. 24, 2003

(51) Int. Cl. B32B 27/38

(52) U.S. Cl. 428/413

(57) ABSTRACT

Reactive one-part hot melt epoxy adhesive formulations, and methods of using the same, are described. The formulations include at least one epoxy resin, at least one tackifier, and at least one latent curing agent, and exhibit relatively good thermal stability, high lap shear strength, high T-peel strength, and adhere to a wide range of substrates. The formulations are especially suitable for use in joining automotive components that are subjected to paint oven or electrodeposition oven treatment.

### FIELD OF THE INVENTION

The present invention relates generally to epoxy adhesives, and more particularly to new and improved reactive one-part hot melt epoxy adhesive formulations.

### BACKGROUND OF THE INVENTION

With respect to the automotive industry, hot melt adhesives have been used to bond stamped metal parts together, as well as SMC (i.e., sheet molded compound) to SMC, or SMC to metal (e.g., steel) parts for automotive assembly purposes. Typical automotive applications of hot melt adhesives can include the bonding of SMC parts such as doors, hoods, tailgates and body panels. Accordingly, the use of these hot melt adhesives has enabled automotive manufacturers to reduce the weight of vehicles, as well as realize cost and labor savings by eliminating the need for other more expensive and complicated joining methods.

Recently, the use of reactive one-part hot melt epoxy adhesives has been suggested for automotive applications because of their ability to rapidly cure and retain relatively high bond strength after exposure to relatively high temperatures, such as those typically encountered in modern automotive paint ovens or electrodeposition ovens. These reactive one-part hot melt epoxy adhesives typically employ a latent catalyst (i.e., curative) that is substantially inert to epoxy cure reactions at room temperature but which will cure rapidly at elevated temperatures.

However, conventional reactive one-part hot melt epoxy adhesives typically have poor thermal stability, low lap shear strength, low T-peel strength, and do not adhere to a wide range of substrates. Thus, the use of reactive one-part hot melt epoxy adhesives in the automotive industry is somewhat limited due to the aforementioned drawbacks.

Therefore, there exists a need for new and improved reactive one-part hot melt epoxy adhesive formulations, and methods of using the same, that exhibit good storage stability, high peel strength, and adherence to a wide range of substrates.

### SUMMARY OF THE INVENTION

In accordance with the general teachings of the present invention, new and improved reactive one-part hot melt epoxy adhesive formulations, and methods for using the same, are provided.

In accordance with a first embodiment of the present invention, a one-part epoxy adhesive formulation is provided, comprising: (1) at least one epoxy resin selected from the group consisting of an epoxy resin that is a liquid reaction product of epichlorohydrin and bisphenol-A, a reaction product of a liquid epoxy resin and bisphenol-A, and combinations thereof, wherein the at least one epoxy resin is present in the range of about 20 to about 77 weight percent based on the total weight of the one-part epoxy adhesive formulation; (2) at least one tackifier present in the range of about 5 to about 10 weight percent based on the total weight of the one-part epoxy adhesive formulation; and (3) at least one latent curing agent present in the range of about 2 to about 8 weight percent based on the total weight of the one-part epoxy adhesive formulation.

In accordance with a second embodiment of the present invention, a one-part epoxy adhesive formulation is provided, comprising: (1) at least one epoxy resin comprised of a liquid reaction product of epichlorohydrin and bisphenol-A, wherein the at least one epoxy resin is present in the range of about 38 to about 50 weight percent based on the total weight of the one-part epoxy adhesive formulation; (2) at least one other epoxy resin comprised of a reaction product of a liquid epoxy resin and bisphenol-A, wherein the at least one other epoxy resin is present in the range of about 20 to about 27 weight percent based on the total weight of the one-part epoxy adhesive formulation; (3) at least one tackifier present in the range of about 5 to about 10 weight percent based on the total weight of the one-part epoxy adhesive formulation; and (4) at least one latent curing agent present in the range of about 2 to about 8 weight percent based on the total weight of the one-part epoxy adhesive formulation.

In accordance with a third embodiment of the present invention, a one-part epoxy adhesive formulation is provided, comprising: (1) at least one epoxy resin comprised of a liquid reaction product of epichlorohydrin and bisphenol-A, wherein the at least one epoxy resin is present in the range of about 38 to about 50 weight percent based on the total weight of the one-part epoxy adhesive formulation; (2) at least one other epoxy resin comprised of a reaction product of a liquid epoxy resin and bisphenol-A, wherein the at least one other epoxy resin is present in the range of about 20 to about 27 weight percent based on the total weight of the one-part epoxy adhesive formulation; (3) at least one phenoxy resin present in the range of about 20 to about 25 weight percent based on the total weight of the one-part epoxy adhesive formulation; (4) at least one impact modifier present in the range of about 4 to about 10 weight percent based on the total weight of the one-part epoxy adhesive formulation; (5) at least one tackifier present in the range of about 5 to about 10 weight percent based on the total weight of the one-part epoxy adhesive formulation; (6) at least one latent curing agent present in the range of about 2 to about 8 weight percent based on the total weight of the one-part epoxy adhesive formulation; (7) at least one accelerator present in the range of about 0.1 to about 1.5 weight percent based on the total weight of the one-part epoxy adhesive formulation; and (8) at least one thickener present in the range of about 0.1 to about 1.5 weight percent based on the total weight of the one-part epoxy adhesive formulation.

In accordance with a fourth embodiment of the present invention, an automotive component system is provided, comprising: (1) a first automotive component member; (2) a second automotive component member; and (3) a one-part epoxy adhesive formulation disposed therebetween, the formulation comprising: (a) at least one epoxy resin selected from the group consisting of an epoxy resin that is a liquid reaction product of epichlorohydrin and bisphenol-A, a reaction product of a liquid epoxy resin and bisphenol-A, and combinations thereof, wherein the at least one epoxy resin is present in the range of about 20 to about 77 weight percent based on the total weight of the one-part epoxy adhesive formulation; (b) at least one tackifier present in the range of about 5 to about 10 weight percent based on the total weight of the one-part epoxy adhesive formulation; and (c) at least one latent curing agent present in the range of about 2 to about 8 weight percent based on the total weight of the one-part epoxy adhesive formulation.

In accordance with a fifth embodiment of the present invention, a method for forming an automotive component system is provided, comprising the steps of: (1) providing a first automotive component member; (2) providing a second automotive component member; and (3) applying a one-part epoxy adhesive formulation therebetween, the formulation comprising: (a) at least one epoxy resin selected from the group consisting of an epoxy resin that is a liquid reaction product of epichlorohydrin and bisphenol-A, a reaction product of a liquid epoxy resin and bisphenol-A, and combinations thereof, wherein the at least one epoxy resin is present in the range of about 20 to about 77 weight percent based on the total weight of the one-part epoxy adhesive formulation; (b) at least one phenoxy resin present in the range of about 20 to about 25 weight percent based on the total weight of the one-part epoxy adhesive formulation; (c) at least one impact modifier present in the range of about 4 to about 10 weight percent based on the total weight of the one-part epoxy adhesive formulation; (d) at least one tackifier present in the range of about 5 to about 10 weight percent based on the total weight of the one-part epoxy adhesive formulation; and (e) at least one latent curing agent present in the range of about 2 to about 8 weight percent based on the total weight of the one-part epoxy adhesive formulation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a fragmentary sectional view of an illustrative automotive exterior panel system including a first metallic member bonded to a second metallic member with the one-part epoxy adhesive formulation of the present invention, in accordance with the general teachings of the present invention;

FIG. 2 is a fragmentary sectional view of an illustrative automotive exterior panel system including a non-metallic member bonded to a metallic member with the one-part epoxy adhesive formulation of the present invention, in accordance with the general teachings of the present invention;

FIG. 3 is a fragmentary sectional view of an illustrative automotive exterior panel system including a first non-metallic member bonded to a second non-metallic member with the one-part epoxy adhesive formulation of the present invention, in accordance with the general teachings of the present invention;

FIG. 4 is a perspective view of the one-part epoxy one-part adhesive formulation of the present invention being applied to a first panel member, in accordance with the general teachings of the present invention;

FIG. 5 is a perspective view of a second panel member being brought into contact with the one-part epoxy adhesive formulation of the present invention that has been previously applied to the first panel member, as shown in FIG. 4, in accordance with the general teachings of the present invention;

The same reference numerals refer to the same parts throughout the various Figures.

### DETAILED DESCRIPTION OF THE PREFERRED EMBODIMENTS

The following description of the preferred embodiment(s) is merely exemplary in nature and is in no way intended to limit the invention, its application, or uses.

The present invention is primarily directed to reactive one-part hot melt epoxy adhesive formulations, and methods for using the same. The one-part epoxy adhesive formulations of the present invention are particularly suitable for bonding metallic articles to other metallic articles, metallic articles to non-metallic articles, and non-metallic articles to non-metallic articles. By way of a non-limiting example, the one-part epoxy adhesive formulations of the present invention are particularly suitable for forming automotive exterior panel systems, including metallic and/or non-metallic panel members. By way of another non-limiting example, the one-part epoxy adhesive formulations of the present invention can be employed to bond stamped metal parts together, SMC parts to steel parts, as well as SMC parts to other SMC parts, especially for automotive assembly purposes. By way of still another non-limiting example, the one-part epoxy adhesive formulations of the present invention can be employed to bond thermoset and thermoplastic (e.g., high-energy thermoplastic) parts to various substrates, especially for automotive assembly purposes.

In accordance with the general teachings of the present invention, the one-part epoxy adhesive formulations preferably include at least one epoxy resin and at least one latent epoxy curative that are preferably selectively combined in suitable amounts and under suitable conditions to form (e.g., upon curing at a suitable temperature and/or temperature range) the one-part epoxy adhesive formulations of the present invention.

In accordance with one embodiment of the present invention, at least one liquid epoxy resin is provided. The liquid epoxy resin is preferably a liquid reaction product of epichlorohydrin and bisphenol A. In accordance with a highly preferred embodiment of the present invention, the liquid epoxy resin is comprised of D.E.R. 331, a liquid reaction product of epichlorohydrin and bisphenol A, which is readily commercially available from the Dow Chemical Company (Midland, Mich.).

Typical properties of D.E.R. 331 are set forth in Table I, below:

TABLE I

| Property | Description | Testing Method |
|---|---|---|
| Epoxide Equivalent Weight, | 182-192 | ASTM D-1652 |
| (g/eq) | | |
| Percentage epoxide (%) | 22.4-23.6 | ASTM D-1652 |
| Epoxide Group Content | 5200-5500 | ASTM D-1652 |
| (mmol/kg) | | |
| Viscosity @ 25° C. (77° F.), | 11000-14000 | ASTM D-445 |
| (cps) | | |
| Density @ 25° C. (g/ml) | 1.16 | ASTM D-1475 |
| Color, Platinum Cobalt | 75 | ASTM D-1209 |
| Hydrolyzable Chloride | 500 | RPM 105-D |
| Content, (max. ppm) | | |
| Epichlorohydrin Content | 5 | RPM 900-A |
| (max. ppm) | | |
| Non-volatile Content, (wt. %) | 100 | RPM 104-B |
| Flash Point, (° C.) | 252 | ASTM D-93 |
| Water content (max. ppm) | 700 | ASTM E-203 |

In accordance with a preferred embodiment of the present invention, the liquid epoxy resin is present in the range of about 38 to about 50 weight percent, based on the total weight of the epoxy one-part adhesive formulation. In accordance with a more preferred embodiment of the present invention, the liquid epoxy resin is present in the range of about 39 to about 45 weight percent, based on the total weight of the epoxy one-part adhesive formulation. In accordance with a highly preferred embodiment of the present invention, the liquid epoxy resin is present in the range of about 40 to about 42 weight percent, based on the total weight of the epoxy one-part adhesive formulation.

Without being bound to a particular theory of the operation of the present invention, it is believed that amounts of the liquid epoxy resin less than about 38 weight percent, based on the total weight of the epoxy one-part adhesive formulation, may lead to relatively lower physical strength in the cured epoxy one-part adhesive formulation of the present invention. Without being bound to a particular theory of the operation of the present invention, it is believed that amounts of the liquid epoxy resin greater than about 50 weight percent, based on the total weight of the epoxy one-part adhesive formulation, may lead to relatively greater brittleness in the cured epoxy one-part adhesive formulation of the present invention.

In accordance with one embodiment of the present invention, at least one solid epoxy resin is provided. The solid epoxy resin is preferably a reaction product of a liquid epoxy resin and bisphenol A. In accordance with a highly preferred embodiment of the present invention, the solid epoxy resin is comprised of D.E.R. 661, a solid reaction product of a liquid epoxy resin and bisphenol A, which is readily commercially available from the Dow Chemical Company (Midland, Mich.).

Typical properties of D.E.R. 661 are set forth in Table II, below:

TABLE II

| Property | Description | Testing Method |
|---|---|---|
| Epoxide Equivalent Weight, | 500-560 | ASTM D-1652 |
| (g/eq) | | |
| Viscosity @ 25° C. (77° F.), | 165-250 | ASTM D-445 |
| (cSt) | | |
| Melt Viscosity @ 150° C. | 400-800 | ASTM D-4287 |
| (mPa · s) | | |
| Softening Point, (° C.), | 75-85 | RPM 108-C |
| Particulate Rating | Pass | DowM 101668 |
| Color, Platinum Cobalt | 100 Max. | ASTM D-1209 |
| Water content (ppm) | 5000 Max. | ASTM E-203 |

In accordance with a preferred embodiment of the present invention, the solid epoxy resin is present in the range of about 20 to about 27 weight percent, based on the total weight of the epoxy one-part adhesive formulation. In accordance with a more preferred embodiment of the present invention, the solid epoxy resin is present in the range of about 22 to about 26 weight percent, based on the total weight of the epoxy one-part adhesive formulation. In accordance with a highly preferred embodiment of the present invention, the solid epoxy resin is present in the range of about 24 to about 25 weight percent, based on the total weight of the epoxy one-part adhesive formulation.

Without being bound to a particular theory of the operation of the present invention, it is believed that amounts of the solid epoxy resin less than about 20 weight percent, based on the total weight of the epoxy one-part adhesive formulation, may lead to relatively lower physical strength and tack temperature in the cured epoxy one-part adhesive formulation of the present invention. Without being bound to a particular theory of the operation of the present invention, it is believed that amounts of the solid epoxy resin greater than about 27 weight percent, based on the total weight of the epoxy one-part adhesive formulation, may lead to relatively increased process temperature and greater brittleness in the cured epoxy one-part adhesive formulation of the present invention.

In accordance with one embodiment of the present invention, at least one phenoxy resin is provided. The phenoxy resin is preferably powdered. In accordance with a highly preferred embodiment of the present invention, the phenoxy resin is comprised of PAPHEN PKHP-200, a powdered phenoxy resin that is readily commercially available from Phenoxy Specialties (Rock Hill, S.C.).

Typical properties of PAPHEN PKHP-200 are set forth in Table III, below:

TABLE III

| Property | Value |
|---|---|
| Appearance | Opaque, White |
| Form | Fine Powder |
| | (200 μm maximum particle size) |
| Molecular Weight, Mn | 10,000-16,000 |
| Molecular Weight, Mw | 50,000-60,000 |
| Nonvolatiles, % by weight, min. | 99 |
| Specific Gravity at 23° C. | 1.17 to 1.19 |

In accordance with a preferred embodiment of the present invention, the phenoxy resin is present in the range of about 20 to about 25 weight percent, based on the total weight of the epoxy one-part adhesive formulation. In accordance with a more preferred embodiment of the present invention, the phenoxy resin is present in the range of about 21 to about 24 weight percent, based on the total weight of the epoxy one-part adhesive formulation. In accordance with a highly preferred embodiment of the present invention, the phenoxy resin is present in the range of about 22 to about 23 weight percent, based on the total weight of the epoxy one-part adhesive formulation.

Without being bound to a particular theory of the operation of the present invention, it is believed that amounts of the phenoxy resin less than about 20 weight percent, based on the total weight of the epoxy one-part adhesive formulation, may lead to relatively lower toughness and tack temperature in the cured epoxy one-part adhesive formulation of the present invention. Without being bound to a particular theory of the operation of the present invention, it is believed that amounts of the phenoxy resin greater than about 25 weight percent, based on the total weight of the epoxy one-part adhesive formulation, may lead to relatively increased process temperature in the cured epoxy one-part adhesive formulation of the present invention.

In accordance with one embodiment of the present invention, at least one impact modifier is provided. The impact modifier is preferably comprised of methacrylate butadiene styrene. In accordance with a highly preferred embodiment of the present invention, the impact modifier is comprised of PARALOID EXL-2691 A, a powdered methacrylate butadiene styrene impact modifier that is readily commercially available from Rohm and Haas (Philadelphia, Pa.).

In accordance with a preferred embodiment of the present invention, the impact modifier is present in the range of about 4 to about 10 weight percent, based on the total weight of the epoxy one-part adhesive formulation. In accordance with a more preferred embodiment of the present invention, the impact modifier is present in the range of about 4 to about 8 weight percent, based on the total weight of the epoxy one-part adhesive formulation. In accordance with a highly preferred embodiment of the present invention, the impact modifier is present in the range of about 4 to about 6 weight percent, based on the total weight of the epoxy one-part adhesive formulation.

Without being bound to a particular theory of the operation of the present invention, it is believed that amounts of the impact modifier less than about 4 weight percent, based on the total weight of the epoxy one-part adhesive formulation, may lead to relatively lower toughness, flexibility and peel strength in the cured epoxy one-part adhesive formulation of the present invention. Without being bound to a particular theory of the operation of the present invention, it is believed that amounts of the impact modifier greater than about 10 weight percent, based on the total weight of the epoxy one-part adhesive formulation, may lead to relatively increased melt viscosity in the cured epoxy one-part adhesive formulation of the present invention.

In accordance with one embodiment of the present invention, at least one tackifier is provided. In accordance with a preferred embodiment of the present invention, the tackifier is preferably a rosin ester. In accordance with a more preferred embodiment of the present invention, the rosin ester is a semi-solid, stabilized rosin ester. In accordance with a highly preferred embodiment of the present invention, the tackifier is comprised of SYLVATAC RE 40, a semi-solid, stabilized rosin ester that is readily commercially available from Arizona Chemical (Jacksonville, Fla.).

Typical properties of SYLVATAC RE 40 are set forth in Table IV, below:

TABLE IV

| Property | Value |
|---|---|
| Softening Point, Ring & Ball, ° C. | 30-40 |
| Acid Number | 16 Maximum |
| Color, Solid, Gardner | 10 Maximum |
| Melt Viscosity, Brookfield, cps @ 60° C. | 17,000 |
| Melt Viscosit , Brookfield, cps @ 80° C. | 1,400 |
| Melt Viscosity, Brookfield, cps @ 100° C. | 100 |

In accordance with a preferred embodiment of the present invention, the tackifier is present in the range of about 5 to about 10 weight percent, based on the total weight of the epoxy one-part adhesive formulation. In accordance with a more preferred embodiment of the present invention, the tackifier is present in the range of about 5 to about 8 weight percent, based on the total weight of the epoxy one-part adhesive formulation. In accordance with a highly preferred embodiment of the present invention, the tackifier is present in the range of about 5 to about 6 weight percent, based on the total weight of the epoxy one-part adhesive formulation.

Without being bound to a particular theory of the operation of the present invention, it is believed that amounts of the tackifier less than about 5 weight percent, based on the total weight of the epoxy one-part adhesive formulation, may lead to relatively increased tack temperature in the cured epoxy one-part adhesive formulation of the present invention. Without being bound to a particular theory of the operation of the present invention, it is believed that amounts of the tackifier greater than about 10 weight percent, based on the total weight of the epoxy one-part adhesive formulation, may lead to relatively decreased tack temperature and lower physical strength in the cured epoxy one-part adhesive formulation of the present invention.

In accordance with one embodiment of the present invention, at least one latent curing agent is provided. In accordance with a preferred embodiment of the present invention, the latent curing agent is comprised of dicyandiamide. In accordance with a more preferred embodiment of the present invention, the latent curing agent is comprised of a micronized grade of dicyandiamide. In accordance with a highly preferred embodiment of the present invention, the latent curing agent is comprised of AMICURE CG-1200, a micronized grade of dicyandiamide that is readily commercially available from Air Products (Allentown, Pa.).

Typical properties of AMICURE CG-1200 are set forth in Table V, below:

TABLE V

| Property | Value |
|---|---|
| Appearance | White, Crystalline Particles |
| Melt Point (° F.) | 405-406 |
| Particle Size (microns) 90% | <30 |
| Particle Size (microns) 90% | <11 |
| Nitrogen as % of DICY | 99 |
| Equivalent Wt/{H} | 21 |
| Recommended Use Level (phr, | 4-15 |
| EEW = 190) | |
| Gel Time (150 g mass @ 77° F.) (mo) | 12 |
| Tg (° F.) | 250 |

In accordance with a preferred embodiment of the present invention, the latent curing agent is present in the range of about 2 to about 8 weight percent, based on the total weight of the epoxy one-part adhesive formulation. In accordance with a more preferred embodiment of the present invention, the latent curing agent is present in the range of about 3 to about 5 weight percent, based on the total weight of the epoxy one-part adhesive formulation. In accordance with a highly preferred embodiment of the present invention, the latent curing agent is present in the range of about 3 to about 4 weight percent, based on the total weight of the epoxy one-part adhesive formulation.

Without being bound to a particular theory of the operation of the present invention, it is believed that amounts of the latent curing agent less than about 2 weight percent, based on the total weight of the epoxy one-part adhesive formulation, may lead to relatively lower physical strength in the cured epoxy one-part adhesive formulation of the present invention. Without being bound to a particular theory of the operation of the present invention, it is believed that amounts of the latent curing agent greater than about 8 weight percent, based on the total weight of the epoxy one-part adhesive formulation, may lead to relatively lower stability and higher glass transition temperature in the cured epoxy one-part adhesive formulation of the present invention.

In accordance with one embodiment of the present invention, at least one accelerator is provided. In accordance with a preferred embodiment of the present invention, the accelerator is comprised of an aromatic substituted urea. In accordance with a more preferred embodiment of the present invention, the accelerator is comprised of phenyl dimethyl urea. In accordance with a highly preferred embodiment of the present invention, the accelerator is comprised of OMICURE U-405, a phenyl dimethyl urea accelerator that is readily commercially available from CVC Specialty Chemicals (Maple Shade, N.J.).

Typical properties of OMICURE U-405 are set forth in Table VI, below:

TABLE VI

| Property | Value |
|---|---|
| Appearance | Clean Powder |
| Color | Off White |
| Odor | Ammoniacal |
| Melting Point (° C.) | 126-136 |
| Moisture Content, max. % | 0.7 |
| Particle size, min. % through a 325 mesh screen | 80 |

In accordance with a preferred embodiment of the present invention, the accelerator is present in the range of about 0.1 to about 1.5 weight percent, based on the total weight of the epoxy one-part adhesive formulation. In accordance with a more preferred embodiment of the present invention, the accelerator is present in the range of about 0.2 to about 1.2 weight percent, based on the total weight of the epoxy one-part adhesive formulation. In accordance with a highly preferred embodiment of the present invention, the accelerator is present in the range of about 0.5 to about 0.7 weight percent, based on the total weight of the epoxy one-part adhesive formulation.

Without being bound to a particular theory of the operation of the present invention, it is believed that amounts of the accelerator less than about 0.1 weight percent, based on the total weight of the epoxy one-part adhesive formulation, may lead to relatively lower rheology and viscosity in the cured epoxy one-part adhesive formulation of the present invention. Without being bound to a particular theory of the operation of the present invention, it is believed that amounts of the accelerator greater than about 1.5 weight percent, based on the total weight of the epoxy one-part adhesive formulation, may lead to relatively higher viscosity in the cured epoxy one-part adhesive formulation of the present invention.

In accordance with one embodiment of the present invention, at least one thickener is provided. The thickener preferably includes a silica-based thickener, and more preferably, a fumed silica thickener. In accordance with a highly preferred embodiment of the present invention, the fumed silica thickener is comprised of CAB-O-SIL TS-720 and is readily commercially available from Cabot Corp. (Billerica, Mass.).

In accordance with a preferred embodiment of the present invention, the thickener is present in the range of about 0.1 to about 1.5 weight percent, based on the total weight of the epoxy one-part adhesive formulation. In accordance with a more preferred embodiment of the present invention, the thickener is present in the range of about 0.2 to about 1.2 weight percent, based on the total weight of the epoxy one-part adhesive formulation. In accordance with a highly preferred embodiment of the present invention, the thickener is present in the range of about 0.5 to about 0.7 weight percent, based on the total weight of the epoxy one-part adhesive formulation.

Without being bound to a particular theory of the operation of the present invention, it is believed that amounts of the thickener less than about 0.1 weight percent, based on the total weight of the epoxy one-part adhesive formulation, may lead to relatively lower rheology and viscosity in the cured epoxy one-part adhesive formulation of the present invention. Without being bound to a particular theory of the operation of the present invention, it is believed that amounts of the thickener greater than about 0.5 weight percent, based on the total weight of the epoxy one-part adhesive formulation, may lead to relatively increased viscosity in the cured epoxy one-part adhesive formulation of the present invention.

In accordance with a non-limiting example, the reactive one-part hot melt epoxy adhesive formulation of the present invention may be manufactured in any number of suitable manners. For example, the following procedure may be employed to blend the respective ingredients of the reactive one-part hot melt epoxy adhesive formulation of the present invention. First, a suitable mixer, such as a double planetary mixer available from Ross (Hauppauge, N.Y.), is provided. The mixer is then maintained at a temperature of about 120° C. Next, the least one epoxy resin comprised of a liquid reaction product of epichlorohydrin and bisphenol-A (in amounts in the range of about 30-32 weight percent based on the total weight of the reactive one-part hot melt epoxy adhesive of the present invention), the at least one phenoxy resin (in amounts in the range of about 10-12 weight percent base don the total weight of the reactive one-part hot melt epoxy adhesive of the present invention), the at least one impact modifier (in amounts in the range of about 2-6 weight percent based on the total weight of the reactive one-part hot melt epoxy adhesive of the present invention), and the at least one tackifier are combined in the pre-heated mixer (in amounts in the range of about 5-6 weight percent based on the total weight of the reactive one-part hot melt epoxy adhesive of the present invention). The mixer is then actuated and maintained at a temperature in the range of about 100° C. to about 120° C. The mixture is blended until the powder material wets out. Once this occurs, the at least one epoxy resin comprised of the reaction product of a liquid epoxy resin and bisphenol-A (in amounts in the range of about 24-25 weight percent based on the total weight of the reactive one-part hot melt epoxy adhesive of the present invention), and additional phenoxy resin (in amounts in the range of about 10-12 weight percent based on the total weight of the reactive one-part hot melt epoxy adhesive of the present invention) is added to the first mixture. All of the combined materials are then mixed in the mixer for approximately 20 minutes (with 5 minutes of the disperser being turned) to achieve good dispersion of the materials. At this point, the mixer blade and wall should be scraped. Again, all of the combined materials are then mixed in the mixer for approximately 20 more minutes (with 5 more minutes of the disperser being turned) to achieve good dispersion of the materials. As previously done, the blade of the mixer (and the wall) should be scraped again. The temperature of the mixer should be decreased to about 90° C., whereupon additional amounts of the epoxy resin comprised of a liquid reaction product of epichlorohydrin and bisphenol-A (in amounts in the range of about 10-12 weight percent based on the total weight of the reactive one-part hot melt epoxy adhesive of the present invention) is added to the mixture and blended therein until the temperature of the combined mixture reaches 90° C. At that point, the at least one latent curing agent (in amounts in the range of about 3-4 weight percent based on the total weight of the reactive one-part hot melt epoxy adhesive of the present invention), the at least one accelerator (in amounts in the range of about 0.5-0.7 weight percent based on the total weight of the reactive one-part hot melt epoxy adhesive of the present invention), and the at least one thickener (in amounts in the range of about 0.5-0.7 weight percent based on the total weight of the reactive one-part hot melt epoxy adhesive of the present invention) are added to the mixture and blended until well-dispersed therein (the disperser of the mixer may need to be actuated at this point). The entire mixture is then discharged from the mixer and may be used in accordance with the description contained herein.

The one-part adhesive formulation of the present invention can be applied to various substrates including metallic (e.g., steel, aluminum, magnesium and so forth) and non-metallic (e.g., thermoplastics and thermosets) in order to bond the various substrates to one another. By way of a non-limiting example, the one-part adhesive formulation can be used to bond metallic substrates such as, but not limited to hot dipped galvanized steel, electro-galvanized steel, cold rolled steel, aluminum and magnesium. By way of a non-limiting example, the one-part adhesive formulation can be used to bond non-metallic substrates such as, but not limited to SMC and high surface energy thermoplastics.

By way of a non-limiting example, the one-part adhesive formulations of the present invention can be supplied in film form, at a desired thickness, and can be cut into any number of desired shapes. By way of a non-limiting example, thicknesses of about 10 mil may be employed in film form, with or without an optional carrier film (e.g., wax paper). Of course, thicknesses of less than or more than 10 mil may be employed, as the situation dictates. By way of a non-limiting example, typical applications of the one-part adhesive formulations of the present invention can include the bonding of steel locating hinge washers to a hinge assembly to facilitate doors off/doors on processing through a body shop.

By way of a non-limiting example, the one-part adhesive formulations of the present invention can be applied to a carrier by heating the material to about 120° C. and controlling thickness by using a heated doctor knife. After sufficient cooling, the one-part adhesive formulation of the present invention can be cut into various shapes if needed.

By way of a non-limiting example, the one-part adhesive formulations of the present invention may be formed into large blocks or slabs and then formed into sheets of suitable thickness by running the material through one or more pairs of mill rollers.

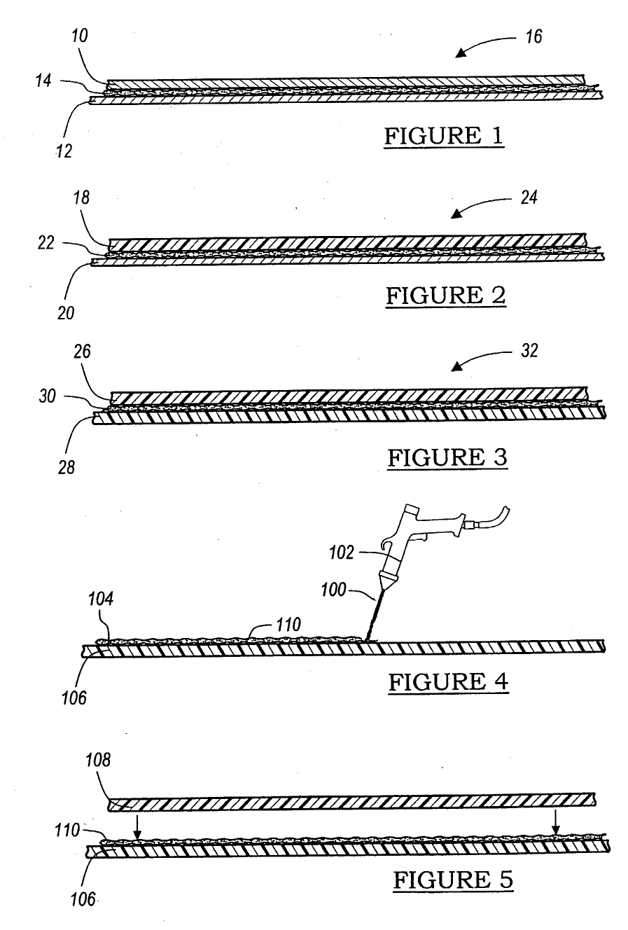

Referring to FIGS. 1-3, the one-part adhesive formulation of the present invention is shown: bonding a metallic member 10 to another metallic member, 12 with the one-part adhesive formulation 14 disposed therebetween to form a metallic panel system 16 (FIG. 1); bonding a metallic member 18 to a non-metallic member 20, with the one-part adhesive formulation 22 disposed therebetween to form a metallic/non-metallic panel system 24 (FIG. 2); and bonding a non-metallic member 26 to another non-metallic member 28, with the one-part adhesive formulation 30 disposed therebetween to form a non-metallic panel member system 32 (FIG. 3).

One application of the one-part adhesive formulation of the present invention can include, without limitation, the bonding of SMC parts such as automotive doors, hoods, tailgates and other body panels. The bonding process can be carried out at a manufacturing facility (e.g., stamping plant), assembly facility (automotive plant), or repair facility (e.g., body shop).

Once the individual components of the one-part adhesive formulation are combined in accordance with the previously described ratios, the one-part adhesive formulation of the present invention is preferably be applied to at least one of the respective surface(s) to be joined together. By way of non-limiting examples, the one-part adhesive formulation can be: (1) applied to one surface of an article or component to be bonded to another article or component; and/or (2) applied to one or more surfaces of adjacent or abutting surfaces of two or more articles or components to be bonded together. Because a latent curing agent is used in the one-part adhesive formulation of the present invention, premature curing will not occur until the requisite temperature is achieved.

By way of a non-limiting example, the one-part adhesive formulation of the present invention is preferably applied to a surface at a temperature of about 110° C. or greater, more preferably at a temperature of about 130° C. or greater, and most preferably in the range of about 110° C. to about 130° C.

By way of a non-limiting example, the one-part adhesive formulation is especially well suited to use in paint ovens and electrodeposition ovens, such as those used to paint automotive components, such as but not limited to exterior panel members. Without being bound to a particular theory of the operation of the present invention, it is believed that curing of the one-part adhesive formulation of the present invention commences at about 150° C. By way of a non-limiting example, the one-part adhesive formulation of the present invention may achieve final cure strength in a paint oven or an electrodeposition oven at a temperature of about 190° C. after about 30 minutes.

The one-part adhesive formulation of the present invention is preferably capable of being applied to a surface either manually or automatically, and can preferably be applied with a pump, sprayer, roller, dipper, and any other suitable methods. By way of a non-limiting example, the one-part adhesive formulation of the present invention can be streamed, swirled, extruded, roll coated, flow coated, flow brushed or spray applied onto a surface.

With reference to FIGS. 4-5, the one-part adhesive formulation 100 of the present invention is shown being applied, with an extrusion nozzle 102, to a surface 104 of a first member 106 (the exact configuration of the member is not thought to be critical to the success of the present invention). A second member 108, whether or not containing additional amounts of the one-part adhesive formulation 100 of the present invention, is then brought into contact with the adhesive-containing surface 110 of the first member 106. The respective members and one-part adhesive formulation of the present invention are then exposed to a heat source (e.g., an oven) maintained at a temperature sufficient to cause the latent curing agent to commence curing and for a time sufficient to allow the latent curing agent to a achieve a suitable level of curing strength. In this manner, the two members 106, 108 will be securely bonded to one another upon curing of the one-part adhesive formulation of the present invention.

In order to determine the effectiveness of the one-part adhesive formulation of the present invention several comparative tests were conducted to evaluate the performance of the one-part adhesive formulation of the present invention.

In the first series of tests, heat stability of the uncured one-part adhesive formulation of the present invention was evaluated against a comparative experimental reactive one-part hot melt epoxy adhesive formulation. The formulations of the respective adhesives, expressed in terms of weight percent, are presented in Table VII, below:

TABLE VII

| | Components of Sample | |
|---|---|---|
| | 1, prepared in | |
| | accordance with the | Components |
| | general teachings of the | of Comparative |
| | present invention, | Sample 1 |
| Commercial Name of | expressed in weight | expressed in |
| Component | percent | weight percent |
| D.E.R. 331 | 40-42 | 40-42 |
| D.E.R. 661 | 24-25 | 24.3 |
| PKHP-200 | 22-23 | 22 |
| PARALOID EXL-2691 A | 4-6 | 4 |
| SYLVATAC RE 40 | 5-6 | 4 |
| ANCAMINE 2014 AS | 0 | 1 |
| (Latent Curing | | |
| Agent/Accelerator | | |
| Available from Air | | |
| Products) | | |
| AMICURE CG-1200 | 3-4 | 3-4 |
| OMICURE U-405 | 0.5-0.7 | 0.5-0.7 |
| CAB-O-SIL TS-720 | 0.5-0.7 | 0.6 |
| Heat Stability | >1 hour @ 80° C. | <1 hour @ 80° C. |

As the results in Table VII illustrate, the one-part adhesive formulation of the present invention exhibits superior heat stability as compared to the comparative one-part epoxy adhesive formulation.

In the second series of tests, tackiness of the uncured one-part adhesive formulation of the present invention was evaluated against two comparative experimental reactive one-part hot melt epoxy adhesive formulations. The formulations of the respective adhesives, expressed in terms of weight percent, are presented in Table VIII, below:

TABLE VIII

| | Components of | | |
|---|---|---|---|
| | Sample 1, | | |
| | prepared in | | Components |
| | accordance with | | of |
| | the general | Components of | Comparative |
| | teachings of the | Comparative | Sample 3 |
| Commercial | present invention, | Sample 2 | expressed |
| Name of | expressed in | expressed in | in weight |
| Component | weight percent | weight percent | percent |
| D.E.R. 331 | 40-42 | 46 | 45 |
| D.E.R. 661 | 24-25 | 18.2 | 20.2 |
| PKHP-200 | 22-23 | 21 | 18 |
| PARALOID EXL- | 4-6 | 0 | 4 |
| 2691 A | | | |
| SYLVATAC RE | 5-6 | 10 | 8 |
| 40 | | | |
| AMICURE CG- | 3-4 | 3.5 | 3.5 |
| 1200 | | | |
| OMICURE U-405 | 0.5-0.7 | 0.6 | 0.6 |
| CAB-O-SIL TS- | 0.5-0.7 | 0.7 | 0.7 |
| 720 | | | |
| Tackiness | Tack-free @ 25° C. | Tacky @ | Tacky @ |
| | | 25° C. | 25° C. |

As the results in Table VIII illustrate, the one-part adhesive formulation of the present invention exhibits superior tack properties as compared to the comparative one-part epoxy adhesive formulations.

In the third series of tests, lap shear strength of the cured one-part adhesive formulation of the present invention (shown in Table VIII) was evaluated against two comparative experimental reactive one-part hot melt epoxy adhesive formulations (shown in Table VIII). The results of the tests are presented in Table IX, below:

TABLE IX

| | | Lap Shear | | |
|---|---|---|---|---|
| | | Strength, | | |
| | | expressed in | | |
| | | psi, of | | |
| | | Sample 1, | | |
| | | prepared in | | |
| | | accordance | Lap Shear | Lap Shear |
| | | with the | Strength, | Strength, |
| | | general | expressed in | expressed |
| | | teachings of | psi, of | in psi, of |
| Cure | | the present | Comparative | Comparative |
| Condition | Substrate | invention | Sample 2 | Sample 3 |
| 5 minutes @ | Hot Dipped | 26 | 0 | 29 |
| 300° F. | Galvanized | | | |
| | Steel | | | |
| 15 minutes @ | Hot Dipped | 48 | 10 | 47 |
| 250° F. | Galvanized | | | |
| | Steel | | | |

As the results in Table IX illustrate, the one-part adhesive formulation of the present invention exhibits superior lap shear strength properties, for both use with either hot dipped galvanized steel and cold rolled steel along a wide time and temperature range, as compared to the comparative one-part epoxy adhesive formulations. Thus, these results indicate that the one-part adhesive formulation of the present invention would be especially well suited for relatively high-temperature and/or long-exposure heating conditions, such as those found in electrodeposition ovens.

In the fourth series of tests, T-peel strength of the cured one-part adhesive formulation of the present invention (shown in Table VIII) was evaluated against two comparative experimental reactive one-part hot melt epoxy adhesive formulations (shown in Table VIII). The results of the tests are presented in Table X, below:

TABLE X

| | | T-Peel | | |
|---|---|---|---|---|
| | | Strength, | | |
| | | expressed in | | |
| | | pli, of | | |
| | | Sample 1, | | |
| | | prepared in | | |
| | | accordance | T-Peel | T-Peel |
| | | with the | Strength, | Strength, |
| | | general | expressed in | expressed |
| | | teachings of | pli, of | in pli, of |
| Cure | | the present | Comparative | Comparative |
| Condition | Substrate | invention | Sample 2 | Sample 3 |
| 5 minutes @ | Hot Dipped | 26 | 0 | 29 |
| 300° F. | Galvanized | | | |
| | Steel | | | |
| 15 minutes @ | Hot Dipped | 48 | 10 | 47 |
| 250° F. | Galvanized | | | |
| | Steel | | | |

As the results in Table X illustrate, the one-part adhesive formulation of the present invention exhibits superior, or at least comparable, T-peel strength properties, along a wide time and temperature range, as compared to the comparative one-part epoxy adhesive formulations. Thus, these results indicate that the one-part adhesive formulation of the present invention would be especially well suited for relatively high-temperature and/or long-exposure heating conditions, such as those found in electrodeposition ovens.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A one-part epoxy adhesive formulation, comprising:
at least one epoxy resin selected from the group consisting of an epoxy resin that is a liquid reaction product of epichlorohydrin and bisphenol-A, a reaction product of a liquid epoxy resin and bisphenol-A, and combinations thereof, wherein the at least one epoxy resin is present in the range of about 20 to about 77 weight percent based on the total weight of the one-part epoxy adhesive formulation;
at least one tackifier present in the range of about 5 to about 10 weight percent based on the total weight of the one-part epoxy adhesive formulation; and
at least one latent curing agent present in the range of about 2 to about 8 weight percent based on the total weight of the one-part epoxy adhesive formulation.

2. The invention according to claim 1, further comprising at least one phenoxy resin present in the range of about 20 to about 25 weight percent based on the total weight of the one-part epoxy adhesive formulation.

3. The invention according to claim 2, wherein the at least one phenoxy resin is present in the range of about 21 to about 24 weight percent based on the total weight of the one-part epoxy adhesive formulation.

4. The invention according to claim 2, wherein the at least one phenoxy resin is present in the range of about 22 to about 23 weight percent based on the total weight of the one-part epoxy adhesive formulation.

5. The invention according to claim 1, further comprising at least one impact modifier present in the range of about 4 to about 10 weight percent based on the total weight of the one-part epoxy adhesive formulation.

6. The invention according to claim 5, wherein the at least one impact modifier is present in the range of about 4 to about 8 weight percent based on the total weight of the one-part epoxy adhesive formulation.

7. The invention according to claim 5, wherein the at least one impact modifier is present in the range of about 4 to about 6 weight percent based on the total weight of the one-part epoxy adhesive formulation.

8. The invention according to claim 1, wherein the epoxy resin that is a liquid reaction product of epichlorohydrin and bisphenol-A is present in the range of about 38 to about 50 weight percent based on the total weight of the one-part epoxy adhesive formulation.

9. The invention according to claim 1, wherein the epoxy resin that is a liquid reaction product of epichlorohydrin and bisphenol-A is present in the range of about 39 to about 45 weight percent based on the total weight of the one-part epoxy adhesive formulation.

10. The invention according to claim 1, wherein the epoxy resin that is a liquid reaction product of epichlorohydrin and bisphenol-A is present in the range of about 40 to about 42 weight percent based on the total weight of the one-part epoxy adhesive formulation.

11. The invention according to claim 1, wherein the epoxy resin that is a reaction product of a liquid epoxy resin and bisphenol-A is present in the range of about 20 to about 27 weight percent based on the total weight of the one-part epoxy adhesive formulation.

12. The invention according to claim 1, wherein the epoxy resin that is a reaction product of a liquid epoxy resin and bisphenol-A is present in the range of about 22 to about 26 weight percent based on the total weight of the one-part epoxy adhesive formulation.

13. The invention according to claim 1, wherein the epoxy resin that is a reaction product of a liquid epoxy resin and bisphenol-A is present in the range of about 24 to about 25 weight percent based on the total weight of the one-part epoxy adhesive formulation.

14. The invention according to claim 1, wherein the at least one tackifier is present in the range of about 5 to about 8 weight percent based on the total weight of the one-part epoxy adhesive formulation.

15. The invention according to claim 1, wherein the at least one tackifier is present in the range of about 5 to about 6 weight percent based on the total weight of the one-part epoxy adhesive formulation.

16. The invention according to claim 1, wherein the at least one latent curing agent present in the range of about 3 to about 5 weight percent based on the total weight of the one-part epoxy adhesive formulation.

17. The invention according to claim 1, wherein the at least one latent curing agent present in the range of about 3 to about 4 weight percent based on the total weight of the one-part epoxy adhesive formulation.

18. The invention according to claim 1, further comprising at least one accelerator.

19. The invention according to claim 18, wherein the at least one accelerator is present in the range of about 0.1 to about 1.5 weight percent based on the total weight of the one-part epoxy adhesive formulation.

20. The invention according to claim 18, wherein the at least one accelerator is present in the range of about 0.2 to about 1.2 weight percent based on the total weight of the one-part epoxy adhesive formulation.

21. The invention according to claim 18, wherein the at least one accelerator is present in the range of about 0.5 to about 0.7 weight percent based on the total weight of the one-part epoxy adhesive formulation.

22. The invention according to claim 1, further comprising at least one thickener.

23. The invention according to claim 22, wherein the at least one thickener is present in the range of about 0.1 to about 1.5 weight percent based on the total weight of the one-part epoxy adhesive formulation.

24. The invention according to claim 22, wherein the at least one thickener is present in the range of about 0.2 to about 1.2 weight percent based on the total weight of the one-part epoxy adhesive formulation.

25. The invention according to claim 22, wherein the at least one thickener is present in the range of about 0.5 to about 0.7 weight percent based on the total weight of the one-part epoxy adhesive formulation.

26. A one-part epoxy adhesive formulation, comprising:
at least one epoxy resin comprised of a liquid reaction product of epichlorohydrin and bisphenol-A, wherein the at least one epoxy resin is present in the range of about 38 to about 50 weight percent based on the total weight of the one-part epoxy adhesive formulation;
at least one other epoxy resin comprised of a reaction product of a liquid epoxy resin and bisphenol-A, wherein the at least one other epoxy resin is present in the range of about 20 to about 27 weight percent based on the total weight of the one-part epoxy adhesive formulation;
at least one tackifier present in the range of about 5 to about 10 weight percent based on the total weight of the one-part epoxy adhesive formulation; and
at least one latent curing agent present in the range of about 2 to about 8 weight percent based on the total weight of the one-part epoxy adhesive formulation.

27. The invention according to claim 26, further comprising at least one phenoxy resin present in the range of about 20 to about 25 weight percent based on the total weight of the one-part epoxy adhesive formulation.

28. The invention according to claim 27, wherein the at least one phenoxy resin is present in the range of about 21 to about 24 weight percent based on the total weight of the one-part epoxy adhesive formulation.

29. The invention according to claim 27, wherein the at least one phenoxy resin is present in the range of about 22 to about 23 weight percent based on the total weight of the one-part epoxy adhesive formulation.

30. The invention according to claim 26, further comprising at least one impact modifier present in the range of about 4 to about 10 weight percent based on the total weight of the one-part epoxy adhesive formulation.

31. The invention according to claim 30, wherein the at least one impact modifier is present in the range of about 4 to about 8 weight percent based on the total weight of the one-part epoxy adhesive formulation.

32. The invention according to claim 30, wherein the at least one impact modifier is present in the range of about 4 to about 6 weight percent based on the total weight of the one-part epoxy adhesive formulation.

33. The invention according to claim 26, wherein the at least one epoxy resin is present in the range of about 39 to about 45 weight percent based on the total weight of the one-part epoxy adhesive formulation.

34. The invention according to claim 26, wherein the at least one epoxy resin is present in the range of about 40 to about 42 weight percent based on the total weight of the one-part epoxy adhesive formulation.

35. The invention according to claim 26, wherein the at least one other epoxy resin is present in the range of about 22 to about 26 weight percent based on the total weight of the one-part epoxy adhesive formulation.

36. The invention according to claim 26, wherein the at least one other epoxy resin is present in the range of about 24 to about 25 weight percent based on the total weight of the one-part epoxy adhesive formulation.

37. The invention according to claim 26, wherein the at least one phenoxy resin is present in the range of about 21 to about 24 weight percent based on the total weight of the one-part epoxy adhesive formulation.

38. The invention according to claim 26, wherein the at least one phenoxy resin is present in the range of about 22 to about 23 weight percent based on the total weight of the one-part epoxy adhesive formulation.

39. The invention according to claim 26, wherein the at least one impact modifier is present in the range of about 4 to about 8 weight percent based on the total weight of the one-part epoxy adhesive formulation.

40. The invention according to claim 26, wherein the at least one impact modifier is present in the range of about 4 to about 6 weight percent based on the total weight of the one-part epoxy adhesive formulation.

41. The invention according to claim 26, wherein the at least one tackifier is present in the range of about 5 to about 8 weight percent based on the total weight of the one-part epoxy adhesive formulation.

42. The invention according to claim 26, wherein the at least one tackifier is present in the range of about 5 to about 6 weight percent based on the total weight of the one-part epoxy adhesive formulation.

43. The invention according to claim 26, wherein the at least one latent curing agent present in the range of about 3 to about 5 weight percent based on the total weight of the one-part epoxy adhesive formulation.

44. The invention according to claim 26, wherein the at least one latent curing agent present in the range of about 3 to about 4 weight percent based on the total weight of the one-part epoxy adhesive formulation.

45. The invention according to claim 26, further comprising at least one accelerator.

46. The invention according to claim 45, wherein the at least one accelerator is present in the range of about 0.1 to about 1.5 weight percent based on the total weight of the one-part epoxy adhesive formulation.

47. The invention according to claim 45, wherein the at least one accelerator is present in the range of about 0.2 to about 1.2 weight percent based on the total weight of the one-part epoxy adhesive formulation.

48. The invention according to claim 45, wherein the at least one accelerator is present in the range of about 0.5 to about 0.7 weight percent based on the total weight of the one-part epoxy adhesive formulation.

49. The invention according to claim 26, further comprising at least one thickener.

50. The invention according to claim 49, wherein the at least one thickener is present in the range of about 0.1 to about 1.5 weight percent based on the total weight of the one-part epoxy adhesive formulation.

51. The invention according to claim 49, wherein the at least one thickener is present in the range of about 0.2 to about 1.2 weight percent based on the total weight of the one-part epoxy adhesive formulation.

52. The invention according to claim 49, wherein the at least one thickener is present in the range of about 0.5 to about 0.7 weight percent based on the total weight of the one-part epoxy adhesive formulation.

53. A one-part epoxy adhesive formulation, comprising:
at least one epoxy resin comprised of a liquid reaction product of epichlorohydrin and bisphenol-A, wherein the at least one epoxy resin is present in the range of about 38 to about 50 weight percent based on the total weight of the one-part epoxy adhesive formulation;
at least one other epoxy resin comprised of a reaction product of a liquid epoxy resin and bisphenol-A, wherein the at least one other epoxy resin is present in the range of about 20 to about 27 weight percent based on the total weight of the one-part epoxy adhesive formulation;
at least one phenoxy resin present in the range of about 20 to about 25 weight percent based on the total weight of the one-part epoxy adhesive formulation;
at least one impact modifier present in the range of about 4 to about 10 weight percent based on the total weight of the one-part epoxy adhesive formulation;
at least one tackifier present in the range of about 5 to about 10 weight percent based on the total weight of the one-part epoxy adhesive formulation;
at least one latent curing agent present in the range of about 2 to about 8 weight percent based on the total weight of the one-part epoxy adhesive formulation;
at least one accelerator present in the range of about 0.1 to about 1.5 weight percent based on the total weight of the one-part epoxy adhesive formulation; and
at least one thickener present in the range of about 0.1 to about 1.5 weight percent based on the total weight of the one-part epoxy adhesive formulation.

54. The invention according to claim 53, wherein the at least one epoxy resin is present in the range of about 39 to about 45 weight percent based on the total weight of the one-part epoxy adhesive formulation.

55. The invention according to claim 53, wherein the at least one epoxy resin is present in the range of about 40 to about 42 weight percent based on the total weight of the one-part epoxy adhesive formulation.

56. The invention according to claim 53, wherein the at least one other epoxy resin is present in the range of about 22 to about 26 weight percent based on the total weight of the one-part epoxy adhesive formulation.

57. The invention according to claim 53, wherein the at least one other epoxy resin is present in the range of about 24 to about 25 weight percent based on the total weight of the one-part epoxy adhesive formulation.

58. The invention according to claim 53, wherein the at least one phenoxy resin is present in the range of about 21 to about 24 weight percent based on the total weight of the one-part epoxy adhesive formulation.

59. The invention according to claim 53, wherein the at least one phenoxy resin is present in the range of about 22 to about 23 weight percent based on the total weight of the one-part epoxy adhesive formulation.

60. The invention according to claim 53, wherein the at least one impact modifier is present in the range of about 4 to about 8 weight percent based on the total weight of the one-part epoxy adhesive formulation.

61. The invention according to claim 53, wherein the at least one impact modifier is present in the range of about 4 to about 6 weight percent based on the total weight of the one-part epoxy adhesive formulation.

62. The invention according to claim 53, wherein the at least one tackifier is present in the range of about 5 to about 8 weight percent based on the total weight of the one-part epoxy adhesive formulation.

63. The invention according to claim 53, wherein the at least one tackifier is present in the range of about 5 to about 6 weight percent based on the total weight of the one-part epoxy adhesive formulation.

64. The invention according to claim 53, wherein the at least one latent curing agent present in the range of about 3 to about 5 weight percent based on the total weight of the one-part epoxy adhesive formulation.

65. The invention according to claim 53, wherein the at least one latent curing agent present in the range of about 3 to about 4 weight percent based on the total weight of the one-part epoxy adhesive formulation.

66. The invention according to claim 53, wherein the at least one accelerator is present in the range of about 0.2 to about 1.2 weight percent based on the total weight of the one-part epoxy adhesive formulation.

67. The invention according to claim 53, wherein the at least one accelerator is present in the range of about 0.5 to about 0.7 weight percent based on the total weight of the one-part epoxy adhesive formulation.

68. The invention according to claim 53, wherein the at least one thickener is present in the range of about 0.2 to about 1.2 weight percent based on the total weight of the one-part epoxy adhesive formulation.

69. The invention according to claim 53, wherein the at least one thickener is present in the range of about 0.5 to about 0.7 weight percent based on the total weight of the one-part epoxy adhesive formulation.

70. An automotive component system, comprising:
a first automotive component member;
a second automotive component member; and
a one-part epoxy adhesive formulation disposed therebetween, the formulation comprising:
at least one epoxy resin selected from the group consisting of an epoxy resin that is a liquid reaction product of epichlorohydrin and bisphenol-A, a reaction product of a liquid epoxy resin and bisphenol-A, and combinations thereof, wherein the at least one epoxy resin is present in the range of about 20 to about 77 weight percent based on the total weight of the one-part epoxy adhesive formulation;
at least one tackifier present in the range of about 5 to about 10 weight percent based on the total weight of the one-part epoxy adhesive formulation; and
at least one latent curing agent present in the range of about 2 to about 8 weight percent based on the total weight of the one-part epoxy adhesive formulation.

71. The invention according to claim 70, wherein the one-part epoxy adhesive formulation further comprises at least one phenoxy resin present in the range of about 20 to about 25 weight percent based on the total weight of the one-part epoxy adhesive formulation.

72. The invention according to claim 71, wherein the at least one phenoxy resin is present in the range of about 21 to about 24 weight percent based on the total weight of the one-part epoxy adhesive formulation.

73. The invention according to claim 71, wherein the at least one phenoxy resin is present in the range of about 22 to about 23 weight percent based on the total weight of the one-part epoxy adhesive formulation.

74. The invention according to claim 70, wherein the one-part epoxy adhesive formulation further comprises at least one impact modifier present in the range of about 4 to about 10 weight percent based on the total weight of the one-part epoxy adhesive formulation.

75. The invention according to claim 74, wherein the at least one impact modifier is present in the range of about 4 to about 8 weight percent based on the total weight of the one-part epoxy adhesive formulation.

76. The invention according to claim 74, wherein the at least one impact modifier is present in the range of about 4 to about 6 weight percent based on the total weight of the one-part epoxy adhesive formulation.

77. The invention according to claim 70, wherein the one-part epoxy adhesive formulation further comprises at least one accelerator present in the range of about 0.1 to about 1.5 weight percent based on the total weight of the one-part epoxy adhesive formulation.

78. The invention according to claim 70, wherein the one-part epoxy adhesive formulation further comprises at least one thickener present in the range of about 0.1 to about 1.5 weight percent based on the total weight of the one-part epoxy adhesive formulation.

79. The invention according to claim 70, wherein the first automotive component member is comprised of a material selected from the group consisting of metals, thermosets, thermoplastics, and combinations thereof.

80. The invention according to claim 70, wherein the second automotive component member is comprised of a material selected from the group consisting of metals, thermosets, thermoplastics, and combinations thereof.

81. The invention according to claim 70, wherein the one-part epoxy adhesive formulation is applied to either the first or second automotive component member at a temperature in the range of about 110° C. to about 130° C.

82. A method for forming an automotive component system, comprising the steps of:
providing a first automotive component member;
providing a second automotive component member; and
applying a one-part epoxy adhesive formulation therebetween, the formulation comprising:
at least one epoxy resin selected from the group consisting of an epoxy resin that is a liquid reaction product of epichlorohydrin and bisphenol-A, a reaction product of a liquid epoxy resin and bisphenol-A, and combinations thereof, wherein the at least one epoxy resin is present in the range of about 20 to about 77 weight percent based on the total weight of the one-part epoxy adhesive formulation;
at least one phenoxy resin present in the range of about 20 to about 25 weight percent based on the total weight of the one-part epoxy adhesive formulation;
at least one impact modifier present in the range of about 4 to about 10 weight percent based on the total weight of the one-part epoxy adhesive formulation;
at least one tackifier present in the range of about 5 to about 10 weight percent based on the total weight of the one-part epoxy adhesive formulation; and
at least one latent curing agent present in the range of about 2 to about 8 weight percent based on the total weight of the one-part epoxy adhesive formulation.

83. The invention according to claim 82, wherein the one-part epoxy adhesive formulation further comprises at least one accelerator present in the range of about 0.1 to about 1.5 weight percent based on the total weight of the one-part epoxy adhesive formulation.

84. The invention according to claim 82, wherein the one-part epoxy adhesive formulation further comprises at least one thickener present in the range of about 0.1 to about 1.5 weight percent based on the total weight of the one-part epoxy adhesive formulation.

85. The invention according to claim 82, wherein the first automotive component member is comprised of a material selected from the group consisting of metals, thermosets, thermoplastics, and combinations thereof.

86. The invention according to claim 82, wherein the second automotive component member is comprised of a material selected from the group consisting of metals, thermosets, thermoplastics, and combinations thereof.

87. The invention according to claim 82, wherein the one-part epoxy adhesive formulation is applied to either the first or second automotive component member at a temperature in the range of about 110° C. to about 130° C.

88. The invention according to claim 82, further comprising the step of curing the one-part epoxy adhesive formulation.
